(19) United States
(12) Patent Application Publication
(10) Pub. No.: US 2003/0009565 A1
(43) Pub. Date: Jan. 9, 2003

(54) Method of establishing peer-to-peer application sessions

(75) Inventor: Shinya Arao, Tokyo (JP)

Correspondence Address: YOUNG & THOMPSON, 745 SOUTH 23RD STREET 2ND FLOOR, ARLINGTON, VA, 22202

(73) Assignee: NEC CORPORATION, Tokyo (JP)

(21) Appl. No.: 10/190,537

(22) Filed: Jul. 9, 2002

(30) Foreign Application Priority Data
Jul. 9, 2001 (JP) 2001-207912

(51) Int. Cl. G06F 15/16

(52) U.S. Cl. 709/227

(57) ABSTRACT

A session establishment method is disclosed. A first data processing unit starts an application to apply for a session to a second data processing unit by using an SIP (Session Initiation Protocol). The second data processing unit permits the session to the first data processing unit by using the SIP. The second data processing unit starts application, and a step, in which the session is established between the applications started by the first and second data processing units. In the session application or permission by using the SIP, application parameters are provided in the payload.

### BACKGROUND OF THE INVENTION

This application claims benefit of Japanese Patent Application No. 2001-106558 filed on Apr. 7, 2001, the contents of which are incorporated by the reference.

The present invention relates to a method of establishing peer-to-peer application sessions.

Java is widely popularized on various operating systems and platforms, and also SIP (Session Initiation Protocol, IETF RFC2543) has been becoming popular as protocol for establishing sessions of peer-to-peer applications. The SIP can have data other than those of SPD (Session Description Protocol, IETF RFC2327) in the payload and can be utilized for establishment of communication among dispersed objects (i.e., session establishment). However, the SIP is not utilized in interactive applications, in which dispersed objects based on Java are used.

It has been impossible to know what RMI (Remote Method Invocation) objects can be utilized in what PCs (personal computers) or servers because of no usually widely popular naming server holding RMI URL as RMI object address. Also, the PC owned by the individual is subject to power-off and also to frequent disconnection from the network because of pull-out of cable connecting to the network therefrom. Therefore, it has been hardly realized a status, in which RMI objects are always in duty service in process accepting state on the PC or like terminal. For this reason, Java application to the peer-to-peer communication could have heretofore been satisfactorily realized.

### SUMMARY OF THE INVENTION

The present invention, accordingly, has an object of providing a session establishment method, in which the SIP is adopted for the establishment of communication among Java RMI dispersed objects to realize various applications to the peer-to-peer communication.

According to an aspect of the present invention, there is provided a session establishment method comprising: a step, in which a first data processing unit applies for a session to a second processing unit by starting an application and using an SIP (Session Initiation Protocol); a step, in which the second data processing unit permits the session to the first data processing unit by using the SIP; a step, in which the second data processing unit starts equal application to the first-mentioned application; and a step, in which the session is established between the applications started by the first and second data processing units. Thus, in the data processing unit supporting the SIP, the caller can start a given RMI application on its own terminal and a plurality of called terminals to realize the peer-to-peer communication among these terminals. It is thus possible to develop various peer-to-peer communication services such as remote education, local community meetings and network games.

According to another aspect of the present invention, there is provided a session establishment method comprising: a step, in which a first data processing unit applies for a session to a second processing unit by starting an application and using an SIP (Session Initiation Protocol); a step, in which the second data processing unit permits the session to the first data processing unit by using the SIP; a step, in which the second data processing unit starts equal application to the first-mentioned application; and a step, in which the session is established between the applications started by the first and second data processing units, wherein the first and/or second data processing units down-load the applications to be started from a repository and then start the applications. Thus, even when the first and second data processing units do not have pertinent applications, the applications can be down-loaded from the repositories and start these applications.

In the session establishment method, the first data processing unit registers a reference of the started application in a first registry, while the second data processing unit registers a reference of the started application in a second registry, whereby the first and second data processing units mutually obtain the opposite side application references. The first and second data processing units can mutually obtain the opposite side application references by registering the application references in the registries, whereby they can utilize the opposite side remote objects in the same manner as utilizing local object Java API.

In the session establishment method, in the step of the session application or permission using the SIP, parameters for the application are included in a payload. With the application parameters provided in the SIP payload, it is possible for the first data processing unit to send out parameters necessary for the establishment of RMI communication between Java objects in the first and second data processing units.

In the session establishment method, URL of the first or second data registry is described in the parameters. With the URL of the registries described in the parameters, the two data processing units can mutually obtain the opposite side application references.

In the session establishment method, URL of the repositories is described in the parameters. With the URI of the registries described in the parameters, the applications to be started in both the data processing units can be reliably down-loaded.

In the session establishment method, the parameters are described in XML form. With the parameters described in the XML form, it is possible to flexibly cope with parameters different in specifications with applications and describe necessary contents.

According to other aspect of the present invention, there is provided a session establishment method comprising steps of: applying a session from a first unit to a second unit by starting an application and using an SIP (Session Initiation Protocol); permitting the session by the second unit to the first unit by using the SIP; starting equal application by the second unit to the application in the first unit; and establishing the session between the applications started by the first and second units.

Other objects and features will be clarified from the following description with reference to attached drawings.

### BRIEF DESCRIPTION OF THE DRAWINGS

FIG. 1 is a view showing the basic constitution of a system using a Java RMI session establishment method based on the SIP according to the present invention;

FIG. 2 is a view illustrating the operation of the embodiment for the establishment of a session among RMI dispersed objects;

FIG. 3 shows examples of RMI application start confirmation window and session establishing window;

FIG. 4 shows examples of INVITE messages included in SIP; and

FIG. 5 shows a system for a foreign language remote lesson according to the present invention.

### PREFERRED EMBODIMENTS OF THE INVENTION

Preferred embodiments of the present invention will now be described with reference to the drawings.

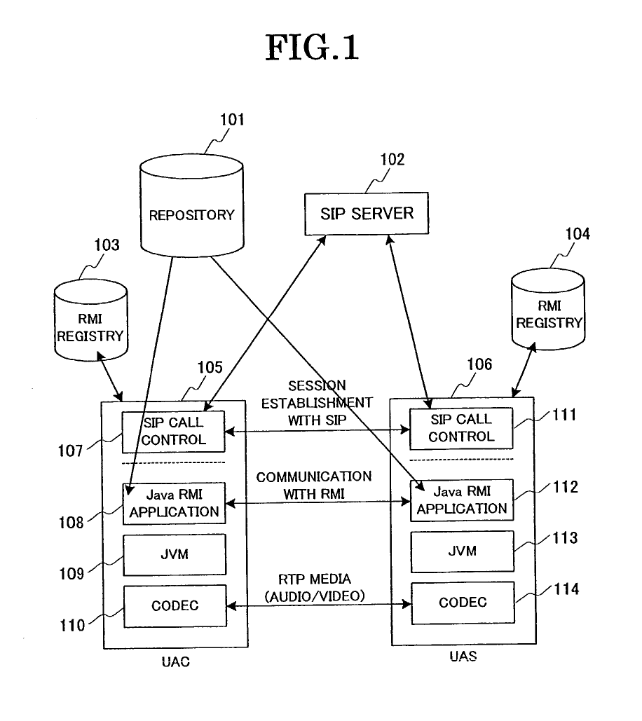

FIG. 1 is a view showing the basic constitution of a system using a Java RMI session establishment method based on the SIP according to the present invention. In the SIP, terminal 105 of multimedia communication is called UAC (User Agent Client), while opposite side terminal 106 is called UAS (User Agent Server). The UAC 105 effects establishment of a multimedia session with respect to the UAS 106 by using the SIP. Audio or video communication can be established among a plurality of multimedia terminals by describing media attribute of RTP (Real-time Transport Protocol, IETF RFC1889) in payload SDF (Session Description Protocol, IETF RFC2327) of an SIP message.

This embodiment features that parameters related to Java RMI applications are described as SIP payload with XML, that instance generation and start of a designated Java object are performed on a plurality of multimedia terminals and that peer-to-peer communication using the RMI is established among these terminals. Here, in the case when the own terminal utilizes the Java object on a different terminal by using the RMI, the Java object on the different terminal is called a remote object. Also, Java programs referred to according to the present invention all utilize the RMI, and are hence hereinafter called RMI applications.

Referring to FIG. 1, an SIP server 102 is used for SIP message routing. For instance, an SIP message sent out from the UAC 105 to the UAS 106, is sent via the SIP server 102. This is not an essential prerequisite of the present invention. Likewise, CODECs 110 and 114 are used only for coding and decoding of audio and video as RTP media, and hence are not an essential prerequisite of the present invention. JVMs (Java Virtual Machines) 109 an 113 are always provided on operating systems and platforms, in which Java can be executed.

Referring to FIG. 1, an SIP call control function 107 in the UAC 105, establishes a session between UAC and UAS by exchanging SIP signaling messages with an SIP call control function 111 in the UAS 106. At this time, the SIP is transferred as a payload in the SIP message for establishing an RTP media session, and related parameters described with the XML are transferred for establishing a session with remote objects. Specifically, when the UAC 105 intends to establish a session with the SIP, it describes a Java object (i.e., RMI application) title desired to be started in the UAS 106 and related parameters in the form of the XML, and sends out the described contents as SIP message payload to the UAS 106. In a repository 101, Java objects are preserved in the form of JARs (Java Archive files), and the UAC 105 and UAS 106 can down-load a specific JAR file that is designated with HTTP (IETF RFC2616) URL by using the HTTP.

The UAC 105 registers an RMI application 108, which has been started in the own terminal prior to the SIP session establishment, with a title provided in an RMI registry 103. After the registration, the UAS 106 can obtain the RMI reference of the Java object started in the UAC 106 by designating an RMI URL corresponding to that Java object. Likewise, an SIP call control function 111 in the UAS 106 registers a Java object, which has been started in the own terminal during the SIP session establishment, with a title provided in the RMI registry 104. After the registration, the UAC 105 can obtain the RMI reference of the RMI application 112 started in the UAS 106 by designating an RMI URL corresponding to the Java object.

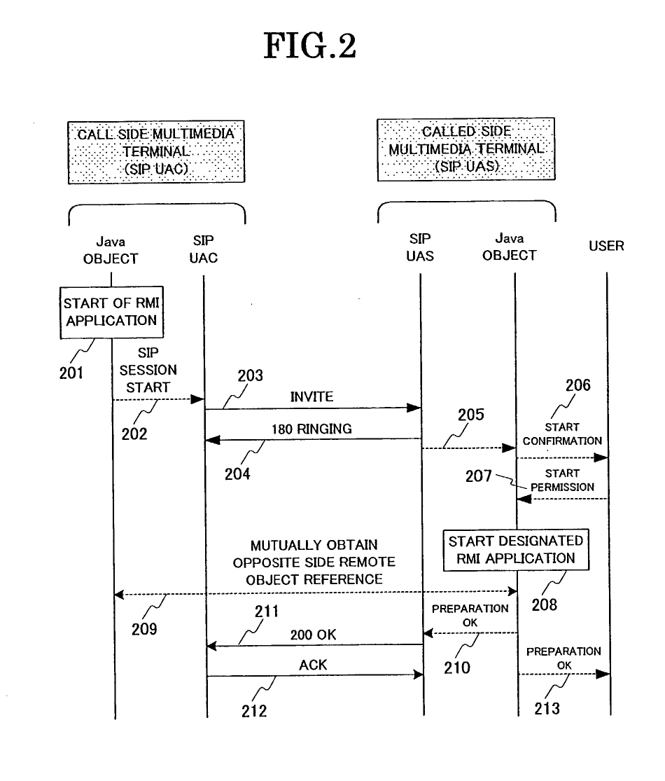

FIG. 2 is a view illustrating the operation of the embodiment at the time of the establishment of a session among RMI dispersed objects. The caller side multimedia terminal (SIP UAC) starts a given RMI application 201. The RMI application 201 causes SIP session start 202 by using a certain API, which is standardized as JAIN by SUN Micros systems. At this time, the RMI application to be started in the UAS side multimedia terminal and the RMI URI registered in the RMI registry 103 are notified to the SIP call control function 107.

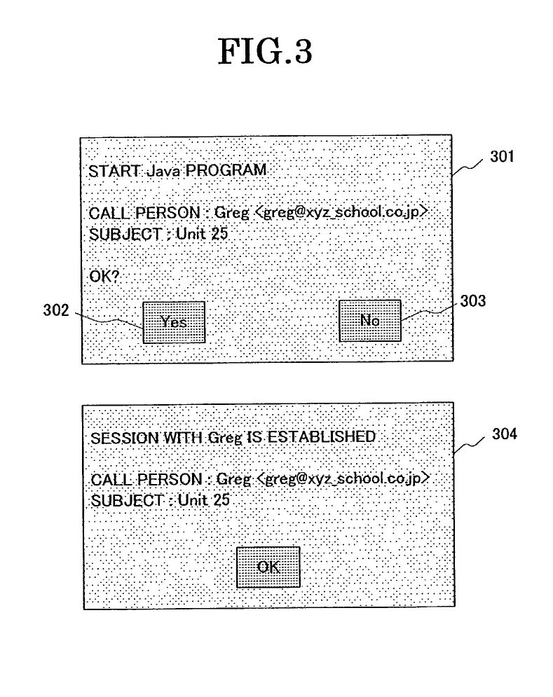

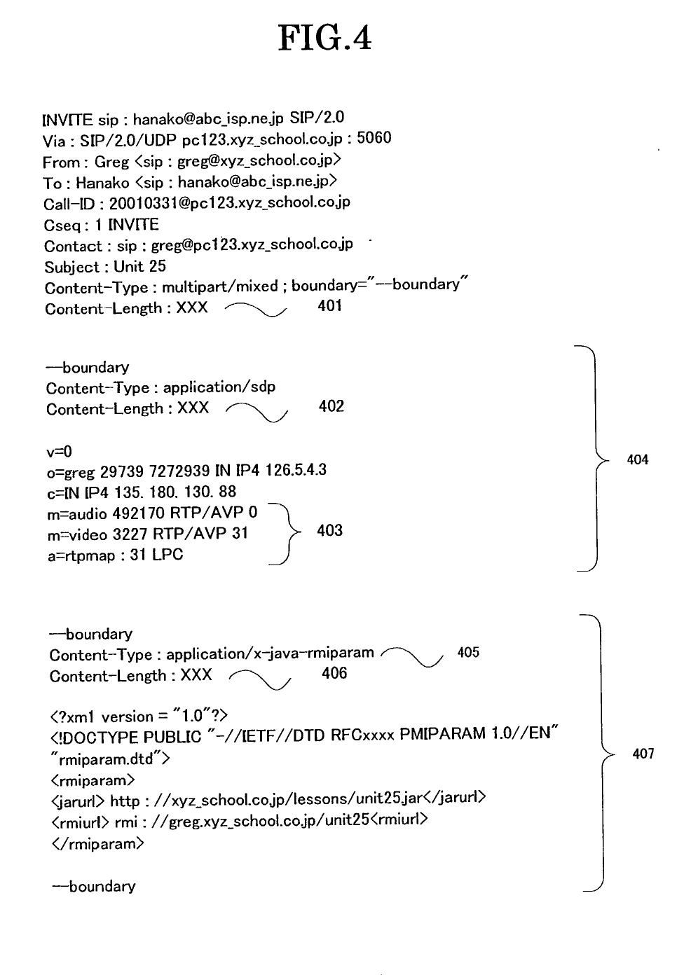

The UAC sends out an INVITE message 203 to the UAS. The UAS immediately returns 180 ringing 204 to the UAC, and performs instance generation of the Java object designated in the INVITE payload with the XML (208). The UAC preliminarily confirms that the instance may be generated to the UAS side user and receives start permission therefrom (206 and 207). In the confirmation, a from-header-field value in INVITE message is displayed as the caller's name, and also the subject title shown in a subject-header-field in the INVITE message are displayed. FIG. 4 shows an example of header-field INVITE messages. A window 301 as shown in FIG. 3 is the confirmation display. The UAS side user permits the start of the designated Java object and continues the session by depressing a “Yes” button 302 in the window. When the user does not permit the start, “No” button is depressed.

FIG. 4 shows an example of actual SIP message. In this INVITE message, labeled 404 is an SDP payload, and labeled 407 is an XML payload as a feature of the present invention. In a line 405, “application/x-java-rmiparam” as MIME (IETF RFC2045) “type title is described. MIME type titles starting with “x-” represent expansion specifications and can be used without formal registration in the IANA. Thus, regarding the MIME type title, any title which can be understood in that multimedia terminal can be provided. Also, the syntax and semantix which are necessary for parameter description with the XML can be defined as desired with XML DTD (Document Type Definition).

Referring to FIG. 4, in the XML description 407, two parts <jarurl http://xyz_school.co.jp/lessons/unit25.jar/jarurl> and <miurlrmi>://greg. .xyz_school.co.jp/unit25 </rmiur1> correspond to parameters representing the HTTP URL and RMI URL in the JAR files. XML tags <jarur1>, </jarur1>,<rmiur1>and </rmiur1>can be defined as desired with the DTD. Parts 401, 402 and 406 represent numeral figures which are variable in dependence on the payload content. The part 401 represents the total byte length of two MIME objects represented by parts 404 and 405, and actually numeral figures are entered in these parts. The part 402 represents the byte length of an SDP part in the part 404, and the part 404 represents the byte length of an XML part in the part 407. A gain numeral figures are entered in these parts. In this example, the MIME object of SDP in the part 404 and the MIME object of XML in the part 407 are sectioned one from the other by a boundary named “boundary”.

According to the parameters designated in the XML description 407, the UAS down-loads a file entitled “unit25, jar” in “http://xyz_school.co.jP/lessons/unit25, jar” as HTTP URL from the registry 101, and starts this file. Before the UAS starts Java program, it should preliminarily have knowledge of the title of Java class, in which a methods title of “main( . . . )” is present. In this connection, the Java class containing the method “main( . . . ) “is described in a manifest in JAR file, and the UAS refers to this.

Referring to FIG. 2, after the UAS has started the designated RMI application, it obtains a reference of the RMI application in the UAC by using “rmiur1://greg.xyz_school.co.jp/unit25” as RMI URL designated by parameter <rmiur1>rmi://greg.xyz_school.co.jp/unit25 </rmiur1> in the XML description 407 in the INVITE message as shown in FIG. 4 (209). Here, since the peer-to-peer communication application is a preamble, it is also conceivable that the UAC conversely utilize the RMI application started in the UAS by using the RMI.

In other words, in FIG. 1, the RMI application 108 can obtain the reference of the RMI application 112 after the RMI application 112 has registered its own RMI URL in the RMI registry 104 and notified this to the RMI application 108. This process depends on the program algorithm of the RMI application. Also, regarding this it is possible to use “SIP message 183 session progress” in RFC 2543-bis as a revision of RFC 2541, although this revision is now in the stage of internet draft. The RMI URL may be transferred as payload of “183, Session Progress” from the UAS to the UAC.

Referring again to FIG. 2, when the establishment of an RMI application session between UAC and UAS has been succeeded (209), the Java application (i.e., RMI application) notifies to the SIP call control function 111 that it is ready to start session (210). The SIP call control function 11 returns 200 OK to the UAC (211), and the UAC returns ACR (212). Thus, a multimedia session including RMI is started with the SIP. At this time, the window 304 shown in FIG. 3 is shown to the UAS side user, thus notifying the establishment of the multimedia session including RMI.

As for the session establishment, not only a session among desired objects but also an audio or vide RTP media session can be established. This is so because the SIP conforms to MIME multipart, thus permitting a plurality of MIME types to be held in payload and permitting transfer of a plurality of MIME objects. FIG. 4 shows an example of pay load described in the MIME multipart. In this example, in the SDP description 403, RTP media based on ITU-T G. 711 μ1aw voice coding system and RTP media based on ITU-T H.261 are designated. Thus, in this example peer-to-peer communication among RMI applications and also audio/video RTP media communication are established.

A foreign language remote lesson will now be described as an actual application of the above embodiment. This case concerns with establishment of a remote English conversation education session among a teacher and two students.

Foreign language teacher Greg starts an RMI application (i.e., Java Program) for a certain lesson. In this example, a program for “Unit 25 Lesson” is started. Necessary Java class is down-loaded as JAR file from a repository 501 (302). This language study program 504 establishes a session with students A (Taro) and B (Hanako) by using the SIP.

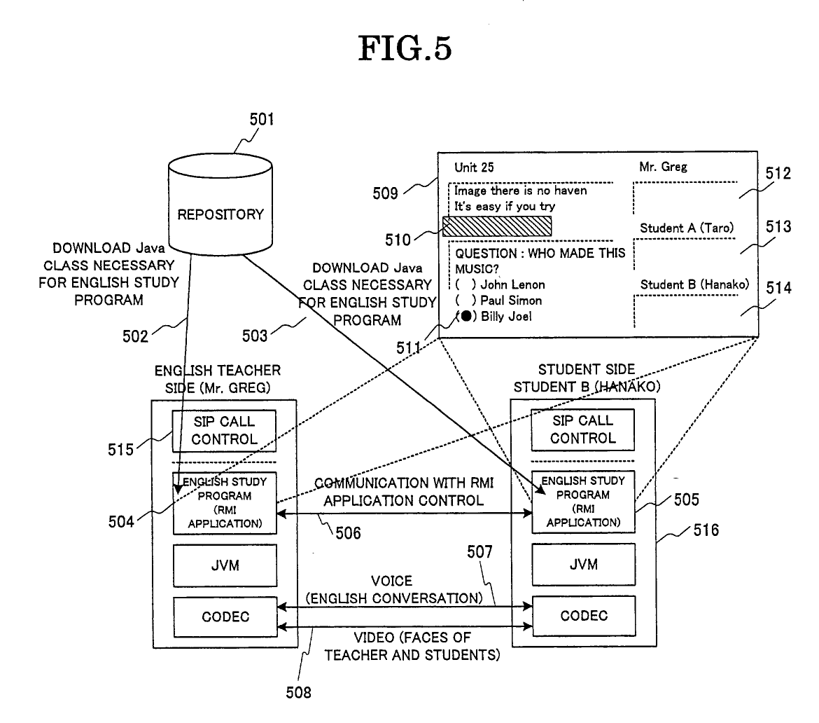

Referring to FIG. 5, two multimedia terminals 515 and 516 supporting the SIP and the Java are shown. The terminals 515 and 516 correspond to the UAC and the UAS, respectively. These multimedia terminals have respective video cameras and microphones mounted in them for sending out faces and voices to each other. Also, these terminals each internally include an SIP call control function, a JVM (Java virtual machine) and a CODEC used for coding and decoding of audio and video. The material used in the foreign language school is constituted by units, and the repository 501 holds these units in the form of JAR files.

The Unit 25” of the English study program is in duty service on the JVM as units 504 and 505 in the UAC and the UAS, respectively. These units communicate with each other with the RMI (506). The CODECs code and decode audio and video RTP media (507 and 508). Designated at 509 is the GUI of the Java program of this English conversation Lesson “Unit 25”. Designated at 510 is a part of the English text, which is tentatively concealed by teacher Greg. Designated at 511 is a part for conducting a quiz type lesson. In parts 512 to 514, the faces of the teacher Greg and students A and B, respectively, are displayed.

The embodiment is realized as a sequence of operations as shown in FIGS. 1 and 2. The windows 301 and 304 shown in FIG. 3 are displayed on the display of the multimedia terminal 516, that is, shown to the user. The INVITE as shown in FIG. 4 is sent out from the multimedia terminal 515 as shown in FIG. 5 to the other multimedia terminal 516. The RMI application is held as JAR file in the repository 501. The multimedia terminals 515 and 516 down-load the program of “Unit 25” as JAR file from “http://xyz_school.co.jp/lessons/unit25, jar” as HTTP URL as in the XML description 407 in FIG. 4. As for the multimedia terminal 516, its RMI application 505 obtains the reference of the RMI application 504 on the multimedia terminal 515 from an address “rmi://xyz_school.co.jp/unit25” as RMI URL as in the XML description 407 in FIG. 4.

The GUI 509 of Java program of “Unit 25”, which is actually used by teacher Greg and students A (Tarro) and B (Hanako), is shown on upper right part of FIG. 5. The GUI is displayed on the multimedia terminals of teacher Greg and students A and B, respectively. The faces of teacher Greg and students A (Taro) and B (Hanako), respectively, are displayed on respective windows 512 to 514. As these faces, images picked up by television cameras mounted on the multimedia terminals are sent out as RTP media. Voices of teacher Greg and students A and B, which are picked up by microphones in the multimedia terminals, are sent out as RTP media. Designated by 510 is a certain part of the English text, which is concealed by teacher Greg. Designated by 511 is an example of a three-selective quiz in the state that the term of “Billy Joel” has been clicked by either student.

The sessions with respect to the students A and B can be established at a time. This is so because these sessions are dealt with as separate calls and thus permit discrimination of the RMI objects of the students A and B as separate RMI URLs. The RMI object of teacher Greg, however, should have recognized that it is in communication with the other two RMI objects. For the common use of the audio and/or video RMI media for the three objects, it may be thought to provide function of an IP multicast or the multimedia terminal 515 of teacher Greg.

The Java application to the peer-to-peer communication has merits that the same state of the GUI, which is produced with a certain part of the English text concealed by teacher Greg as shown at 510 in FIG. 5, is common to the teacher and students A and B and that it is possible to realize an intractive teaching material of quiz type as shown at 511. Furthermore, a remote education status such that an English conversation lesson is held by a teacher and several students around a table and by using the same material, can be realized as on-line status. While this example concerns with the foreign language remote lesson, the present invention also covers various other applications such as network games.

In the multimedia terminal supporting the SIP, the caller can start a given RMI application on its own terminal and a plurality of called terminals to realize the peer-to-peer communication among these terminals. In this way, it is possible to develop various peer-to-peer communication services such as remote education, local community meetings and network games.

The multimedia terminal can utilize the opposite side remote object in the same manner as utilizing the Java API of a local object by obtaining the reference of the remote object started in the opposite side multimedia terminal. Also, at the time of establishing a session with the SIP, the UAC can designate the Java object to be started to the UAS, and can also send out parameters necessary for RMI communication establishment between the Java objects in the UAC and UAS to the UAS.

Furthermore, establishment of audio or video communication among a plurality of multimedia terminals is possible by describing the media attribute of the STP in the payload SDP of SIP message.

Changes in construction will occur to those skilled in the art and various apparently different modifications and embodiments may be made without departing from the scope of the present invention. The matter set forth in the foregoing description and accompanying drawings is offered by way of illustration only. It is therefore intended that the foregoing description be regarded as illustrative rather than limiting.

What is claimed is:

1. A session establishment method comprising:
a step, in which a first data processing unit applies for a session to a second processing unit by starting an application and using an SIP (Session Initiation Protocol);
a step, in which the second data processing unit permits the session to the first data processing unit by using the SIP;
a step, in which the second data processing unit starts equal application to the first-mentioned application; and
a step, in which the session is established between the applications started by the first and second data processing units.

2. A session establishment method comprising:
a step, in which a first data processing unit applies for a session to a second processing unit by starting an application and using an SIP (Session Initiation Protocol);
a step, in which the second data processing unit permits the session to the first data processing unit by using the SIP;
a step, in which the second data processing unit starts equal application to the first-mentioned application; and
a step, in which the session is established between the applications started by the first and second data processing units.
wherein the first and/or second data processing units down-load the applications to be started from a repository and then start the applications.

3. The session establishment method according to one of claims 1 and 2, wherein the first data processing unit registers a reference of the started application in a first registry, while the second data processing unit registers a reference of the started application in a second registry, whereby the first and second data processing units mutually obtain the opposite side application references.

4. The session establishment method according to one of claims 1 to 3, wherein in the step of the session application or permission using the SIP, parameters for the application are included in a payload.

5. The session establishment method according to claim 4, wherein URL of the first or second data registry is described in the parameters.

6. The session establishment method according to one of claims 4 and 5, wherein URL of the repositories is described in the parameters.

7. The session establishment method according to one of claims 4 to 6, wherein the parameters are described in XML form.

8. A session establishment method comprising steps of:
applying a session from a first unit to a second unit by starting an application and using an SIP (Session Initiation Protocol);
permitting the session by the second unit to the first unit by using the SIP;
starting equal application by the second unit to the application in the first unit; and
establishing the session between the applications started by the first and second units.
